(19) United States
(12) Patent Application Publication
(10) Pub. No.: US 2012/0092431 A1
(43) Pub. Date: Apr. 19, 2012

(54) RECORDING MEDIUM CARRYING DEVICE, IMAGE FORMING APPARATUS, AND RECORDING MEDIUM CARRYING METHOD

(75) Inventors: Kazuhiro Hara, Shizuoka-ken (JP); Satoshi Kaiho, Kanagawa-ken (JP); Yasushi Kuribayashi, Shizuoka-ken (JP); Nobuaki Takahashi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/252,339

(22) Filed: Oct. 4, 2011

Related U.S. Application Data
(60) Provisional application No. 61/392,733, filed on Oct. 13, 2010.

(51) Int. Cl. B41J 2/01; B65H 3/18; B65H 3/06

(52) U.S. Cl. 347/104; 271/118; 271/18.2

(57) ABSTRACT

According to one embodiment, an apparatus includes a leading end gripper and a trailing end gripper provided on a drum. The leading end gripper is moved by a leading end gripper driving mechanism. The trailing end gripper switches between a standby position where this gripper is stopped relatively to the rotating drum and a grip position where this gripper rotates with the drum. The leading end gripper and a recording medium pass through an inside of the trailing end gripper stopped in the standby position. If a trailing end of the recording medium reaches the trailing end gripper, the trailing end gripper is released and switches to the grip position. Thus, the trailing end of the medium is held on the drum by the trailing end gripper. The trailing end gripper moves in a rotating direction of the drum while continuing nipping the trailing end of the medium.

### CROSS-REFERENCE TO RELATED APPLICATIONS

This application is based upon and claims the benefit of priority from: U.S. Provisional Application No. 61/392,733 filed on Oct. 13, 2010, the entire contents of each of which are incorporated herein reference.

### FIELD

Embodiments described herein relate generally to a carrying device for carrying a recording medium such as a sheet, an image forming apparatus, and a recording medium carrying method.

### BACKGROUND

For example, an inkjet recording apparatus or the like includes a rotating drum and a recording head unit arranged along a circumferential surface of the drum. A sheet is held on the circumferential surface of the drum. As the drum rotates, the sheet is carried to the recording head unit. To hold the sheet stably on the drum, a drum which has a leading end chuck for fixing a leading end of the sheet and a trailing end chuck for fixing a trailing end of the sheet is known. Also, a drum on which the distance from the leading end chuck to the trailing end chuck can be changed according to the size of the sheet is known. However, with the known drums, the amount of change in the distance from the leading end chuck to the trailing end chuck is small, making it hard to cope with various sheet sizes.

### BRIEF DESCRIPTION OF THE DRAWINGS

FIG. 1 is a side view schematically showing the inside of an image forming apparatus according to an embodiment.

FIG. 2 is a side view showing a part of the image forming apparatus as enlarged.

FIG. 3 is a perspective view showing a sheet carrying device of the image forming apparatus.

FIG. 4 is a side view showing a part of the sheet carrying device.

FIG. 5 is a side view showing the state where a drum of the sheet carrying device is moved from the position shown in FIG. 4.

FIG. 6 is a side view showing the state where the drum is further rotated from the position shown in FIG. 5.

FIG. 7 is a side view showing the state where the drum is further rotated from the position shown in FIG. 6.

FIG. 8 is a side view showing the state where the drum is further rotated from the position shown in FIG. 7.

FIG. 9 is a side view of a part of the sheet carrying device, showing a trailing end gripper driving mechanism.

FIG. 10 is a side view showing the state where a stopper is moved to a protruding position.

FIG. 11 is a side view showing the state where the drum is further rotated from the position shown in FIG. 10.

FIG. 12 is a side view showing the state where the drum is further rotated from the position shown in FIG. 11.

FIG. 13 is a side view showing the state where the drum is further rotated from the position shown in FIG. 12.

FIG. 14 is a side view showing the state where the drum is further rotated from the position shown in FIG. 13 and the stopper is moved to a retreat position.

FIG. 15 is a side view showing the state where the drum is further rotated from the position shown in FIG. 14.

FIG. 16 is an enlarged view showing a part of the sheet carrying device shown in FIG. 13.

FIG. 17 is an enlarged view showing a part of the sheet carrying device shown in FIG. 14.

FIG. 18 is a block diagram showing the configuration of a controller of the image forming apparatus.

FIG. 19 is a flowchart showing an image forming process of the image forming apparatus.

FIG. 20 is a perspective view showing a part of the sheet carrying device and an A4-size sheet.

FIG. 21 is a perspective view showing a part of the sheet carrying device and an A5-size sheet.

FIG. 22 is a perspective view showing a part of the sheet carrying device and an A3-size sheet.

### DETAILED DESCRIPTION

In general, according to one embodiment, an image forming apparatus includes a drum including a circumferential surface to hold a recording medium, a rotation mechanism which rotates the drum in a circumferential direction, at least one leading end gripper arranged on the drum, and at least one trailing end gripper. The leading end gripper is made to open and close by a leading end gripper driving mechanism. The leading end gripper driving mechanism moves the leading end gripper to an open position before a leading end of the recording medium reaches the leading end gripper, and moves the leading end gripper to a closed position when the leading end of the recording medium is inserted in the leading end gripper. The trailing end gripper is switched by a trailing end gripper driving mechanism between a standby position where the trailing end gripper stops relatively to the rotating drum and a grip position where the trailing end gripper moves together with the drum in a rotating direction of the drum.

The trailing end gripper driving mechanism stops the trailing end gripper in the standby position and thereby causes the leading end gripper and the recording medium to pass through an inside of the trailing end gripper. Then, as a trailing end of the recording medium reaches the trailing end gripper, the trailing end gripper driving mechanism releases the trailing end gripper. As the trailing end gripper is released, the trailing end gripper and the recording medium move together with the drum in the rotating direction of the drum. The image forming apparatus also includes a supply mechanism which supplies the recording medium toward the circumferential surface of the drum, a recording head unit which is arranged opposite the circumferential surface of the drum and forms an image on the recording medium, a stripping mechanism which strips the recording medium with the image formed thereon from the drum, and a controller which drives the trailing end gripper driving mechanism according to a size of the recording medium.

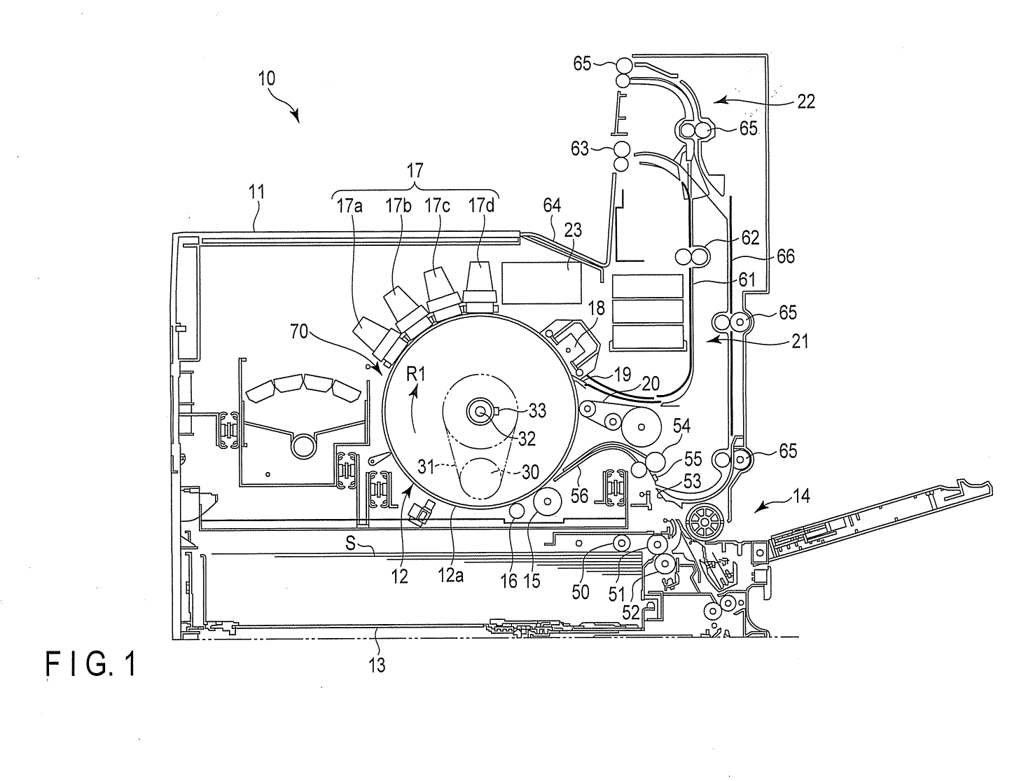

Hereinafter, an image forming apparatus according to an embodiment will be described with reference to FIG. 1 to FIG. 22. FIG. 1 shows an inkjet printer 10 as an example of an image forming apparatus. The inkjet printer 10 (hereinafter referred to as a printer 10) includes a casing 11, a drum 12 housed in the casing 11, and a sheet housing unit 13. The sheet housing unit 13 houses plural sheets S as recording media. Examples of the sheets S may be papers of standard sizes or may be resin films, labels and the like.

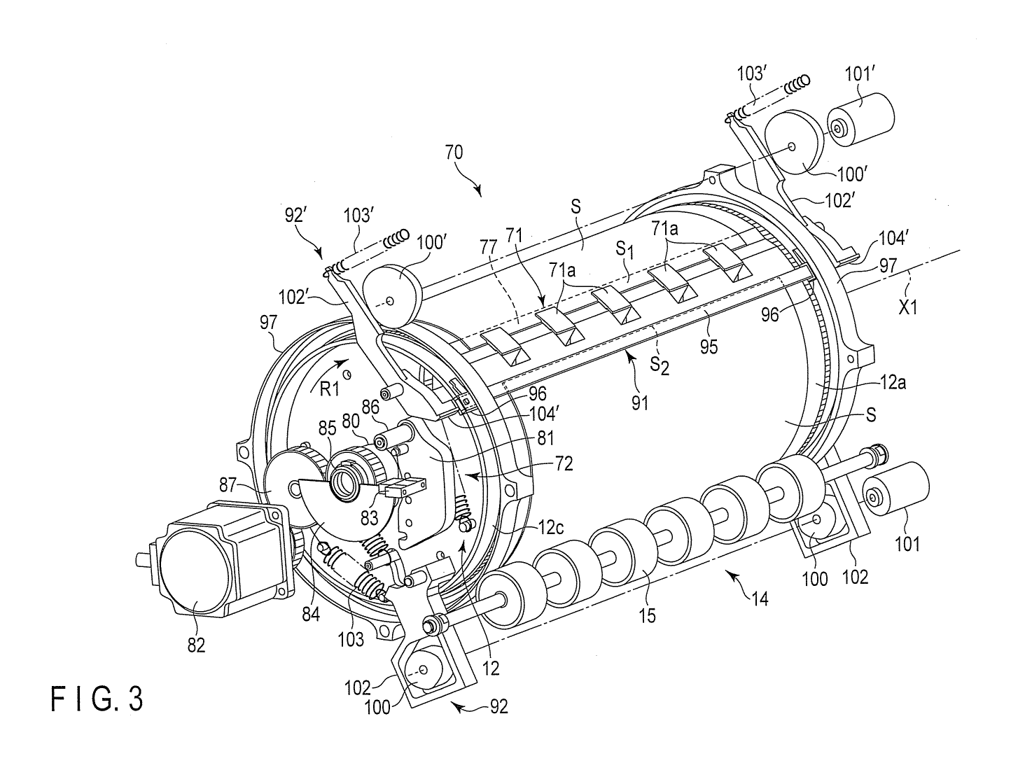

The printer 10 also includes a supply mechanism 14 which supplies the sheet S, a pressing roller 15, a charging roller 16, a recording head unit 17, a neutralizing charger 18, a stripping member 19, a cleaner 20 which cleans the drum 12, a discharge mechanism 21, a reverse mechanism 22, a controller 23 and the like. The neutralizing charger 18 and the stripping member 19 form a stripping mechanism for stripping the sheet S off the drum 12. The charging roller 16, the stripping member 19 and the cleaner 20 include a moving mechanism for being separated from the sheet S, in order not to come into contact with a surface on which an image of the sheet S is formed, when the sheet S passes through after the image formation. The drum 12 is rotated at a predetermined circumferential speed in a direction indicated by arrow R1 about a rotation axis 32, by a rotation mechanism 31 with a motor 30. An axial line X1 (shown in FIG. 3) of the drum 12 passes through the center of the rotation axis 32. The position of the drum 12 in the rotating direction is detected by a rotation angle sensor 33 such as an encoder.

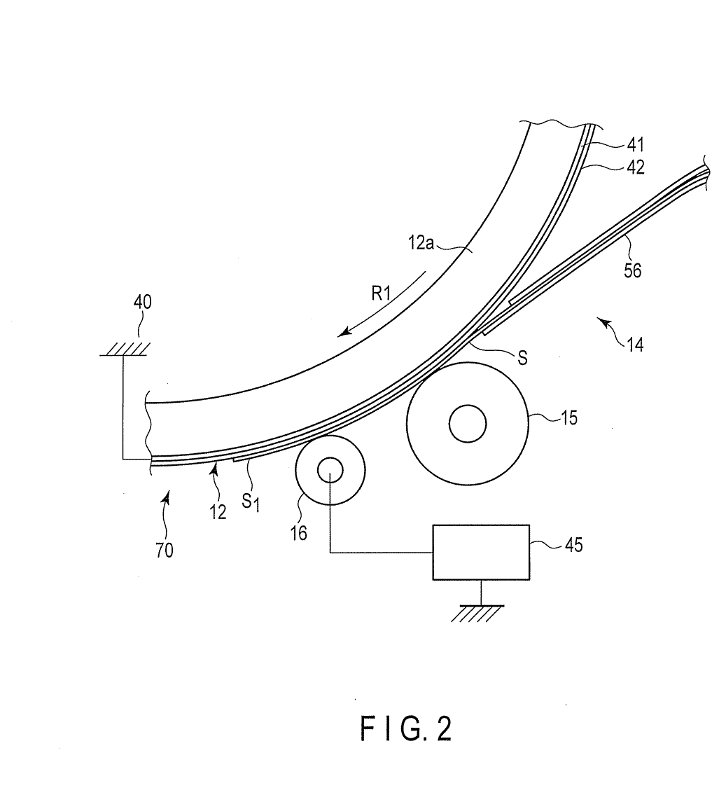

FIG. 2 shows a part of the drum 12, the pressing roller 15, the charging roller 16 and the like. A metal layer 41 and a dielectric layer 42 are provided on a circumferential surface of the drum 12, that is, an outer circumferential surface of a cylindrical part 12a. The metal layer 41 is grounded to a ground 40. The dielectric layer 42 is made up of a resin film and covers the metal layer 41. The charging roller 16 is made of an electroconductive material and is arranged opposite the dielectric layer 42. A power supply circuit 45 is connected to the charging roller 16. The power supply circuit 45 applies a DC voltage (for example, several thousand volts) to the charging roller 16. As the DV voltage is applied to the charging roller 16 by the power supply circuit 45, an electric charge to electrostatically attract the sheet S is generated in the dielectric layer 42 of the drum 12.

This embodiment is configured to attract the sheet S to the drum 12 by electrostatic attraction. However, as another embodiment, a negative pressure chamber may be defined inside the drum and suction holes continuing to the negative pressure chamber may be formed on the circumferential surface of the drum. In such case, the sheet is attracted to the drum 12 by a negative pressure generated in the negative pressure chamber.

As shown in FIG. 1, the supply mechanism 14 includes a pickup roller 50, a sheet supply roller 51, a separation roller 52, a sheet carrying path 53, an aligning roller pair 54, and a sensor 55 which detects the size of the sheet S. The sheet S, taken out one by one by the sheet supply roller 51 and the separation roller 52, is sent to the sheet carrying path 53. The leading end of the sheet S sent to the sheet carrying path 53 is aligned by the aligning roller pair 54. A guide 56 which guides the sheet S toward the drum 12 is provided between the aligning rollers 54 and the drum 12.

An example of the recording head unit 17 has inkjet heads 17a, 17b, 17c and 17d for each color. Each of these inkjet heads 17a, 17b, 17c and 17d is a line head extending in the direction of the axial line X1 (shown in FIG. 3) of the drum 12. Each of the inkjet heads 17a, 17b, 17c and 17d has plural nozzle holes (not shown) for ejecting ink.

An example of the inkjet heads 17a, 17b, 17c and 17d has a piezoelectric element as a driving member. As a voltage is applied to the piezoelectric element, thereby deforming the piezoelectric element and exerting pressure on the ink, the ink is ejected from the nozzle holes. A heating element may be employed as another example of the driving member. As the ink is heated by the heating element, the pressure of bubbles generated by the vaporization of the ink causes the ink to eject from the nozzle holes.

The discharge mechanism 21 includes a carrying guide 61, a carrying roller 62, sheet discharge roller 63, and a sheet discharge table 64. The reverse mechanism 22 has a reverse roller 65, a reverse path 66 and the like for moving the sheet S backward. In the case of performing double-side print, an image is formed on a first side of the sheet S by the recording head unit 17. After that, the sides of the sheet S are reversed by the reverse mechanism 22 and the sheet S is carried again by the drum 12. Then, an image is formed on a second side of the sheet S by the recording head unit 17.

FIG. 3 is a perspective view of a sheet carrying device 70 which carries the sheet S. The sheet carrying device 70 includes the drum 12. The sheet carrying device 70 also includes at least one leading end gripper 71 provided on the drum 12, a leading end gripper driving mechanism 72 for opening and closing the leading end gripper 71, at least one trailing end gripper 91 provided on the drum 12, and a trailing end gripper driving mechanism 92. Both the leading end gripper driving mechanism 72 and the trailing end gripper driving mechanism 92 are arranged on the side of the casing 11 independently of the drum 12. Therefore, neither one of these driving mechanisms rotates integrally with the drum 12.

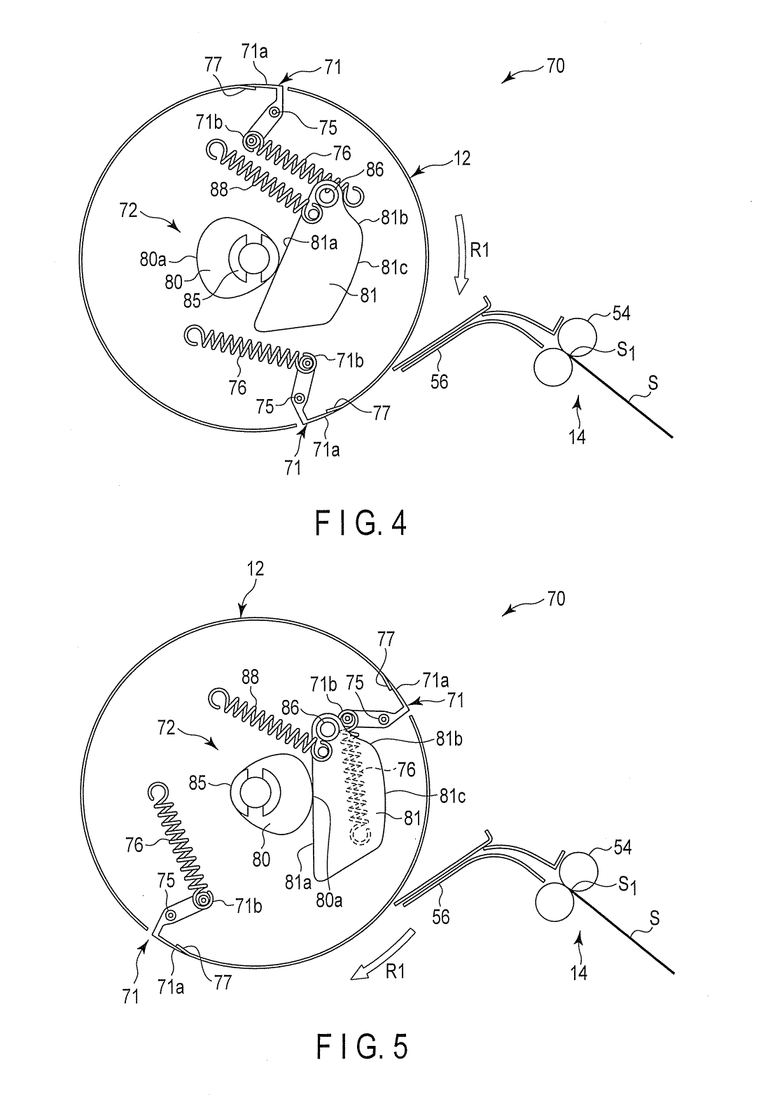

First, the leading end gripper 71 and the leading end gripper driving mechanism 72 will be described. In this embodiment, two leading end grippers 71 are arranged with a space from each other in the circumferential direction of the drum 12. Since these leading end grippers 71 have the same configuration as each other, one of the leading end grippers will be described as a representative. FIG. 4 to FIG. 8 show the leading end gripper 71 and the leading end gripper driving mechanism 72. The leading end gripper 71 has plural grip pawls 71a. The grip pawls 71a are arranged at a predetermined pitch in the direction along the axial line X1 (shown in FIG. 3) of the drum 12.

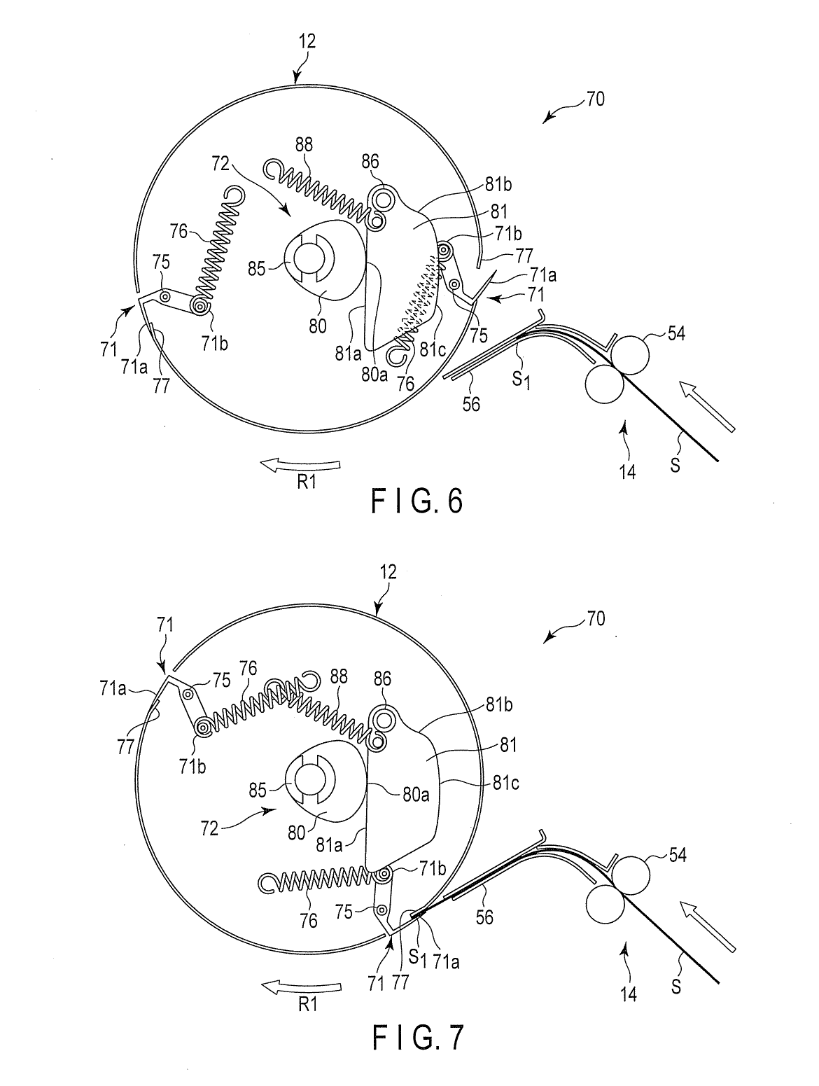

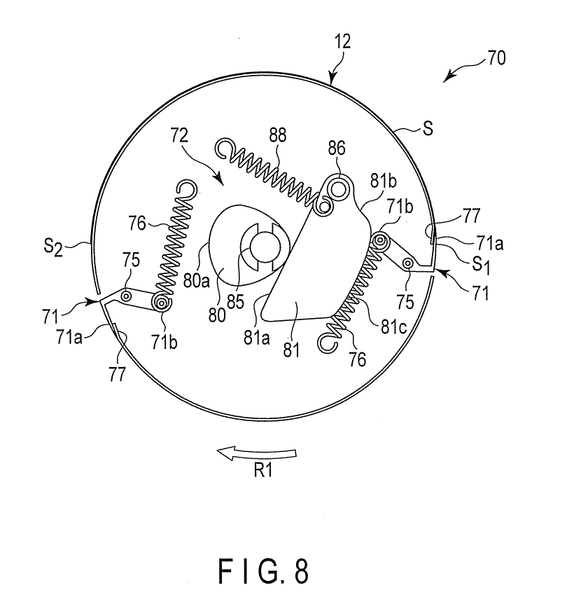

Each grip pawl 71a is movable to a closed position (FIG. 4, FIG. 5, FIG. 7 and FIG. 8) and an open position (FIG. 6) about an axis 75. The leading end gripper 71 is energized toward the closed position by a spring 76. A cam follower 71b is provided at an end part of the leading end gripper 71. When the leading end gripper 71 is at the open position as shown in FIG. 6, each grip pawl 71a opens toward the rear side in the rotating direction of the drum 12.

On the circumferential surface of the drum 12, a sloped concave surface 77 is formed at the position where the grip pawl 71a is arranged. The sloped concaved surface 77 is shaped in an inwardly concave form from the circumferential surface of the drum 12 and continues in the direction of the axial line X1 of the drum 12. As the leading end gripper 71 moves to the closed position as shown in FIG. 7, a leading end S1 of the sheet S is nipped between the grip pawl 71a and the sloped concave surface 77. At this point, the grip pawl 71a fits in the sloped concave surface 77 and therefore the outer surface of the grip pawl 71a becomes a substantially flush surface with the circumferential surface of the drum 12. The leading end S1 of the sheet S bends along the sloped concave surface 77 to retreat inward from the circumferential surface of the drum 12.

The leading end gripper driving mechanism 72 includes a leading end gripper cam 80 with a cam surface 80a, a leading end gripper pusher 81 which contacts the leading end gripper cam 80, a cam driving motor 82 (shown in FIG. 3), a sensor 83, and a sensor target 84. The leading end gripper cam 80 rotates about a cam shaft 85. The rotation of the cam driving motor 82 is transmitted to the leading end gripper cam 80 via a transmission member 87 such as a gear. The position of the leading end gripper cam 80 in the rotating direction is detected by the sensor 83.

The leading end gripper pusher 81 rotates about an axis 86. The leading end gripper pusher 81 has a surface 81a which contacts the leading end gripper cam 80, and first and second cam surfaces 81b and 81c which can contact the cam follower 71b of the leading end gripper 71. The leading end gripper pusher 81 is energized toward the leading end gripper cam 80 by a spring 88.

FIG. 4 and FIG. 8 show the state where the leading end gripper cam 80 is moved to a retreat position. FIG. 5 to FIG. 7 show the state where the leading end gripper cam 80 is rotated 180 degrees and moved to a protruding position. When the leading end gripper cam 80 is at the retreat position (FIG. 4 and FIG. 8), the leading end gripper pusher 81 is moved to a retreat position by the spring 88. At this retreat position, the cam follower 71b is not pushed by the cam surfaces 81b and 81c and therefore the leading end gripper 71 remains at the closed position.

As the leading end gripper cam 80 moves to the protruding position (FIG. 5 to FIG. 7), the leading end gripper pusher 81 is pushed by the cam surface 80a. Therefore, the leading end gripper pusher 81 moves to a protruding position. Then, when the cam follower 71b of the leading end gripper 71 reaches the leading end gripper pusher 81, the cam follower 71b is pushed by the cam surfaces 81b and 81c and therefore the leading end gripper 71 moves to the open position. That is, the cam surfaces 81b and 81c have a cam profile that enables opening of the leading end gripper 71.

Next, the operation of the leading end gripper 71 will be described with reference to FIG. 4 to FIG. 8.

FIG. 4 shows the state where the leading end S₁ of the sheet S is on standby at the aligning roller pair 54. At this point, the leading end gripper cam 80 is stopped at the retreat position. Therefore, the leading end gripper pusher 81 is held at the retreat position by the spring 88. The leading end gripper 71 is kept in the closed position by the elastic force of the spring 76 and rotates together with the drum 12.

FIG. 5 shows the state immediately before the leading end gripper 71 starts moving toward the open position, where the drum 12 is further rotated from the state of FIG. 4. At this point, the leading end gripper cam 80 is rotated 180 degrees from the retreat position and the leading end gripper pusher 81 is moved to the protruding position.

FIG. 6 shows the state where the drum 12 is further rotated from the state of FIG. 5 and the cam follower 71b is running onto the leading end gripper pusher 81. The leading end gripper 71 opens as the cam follower 71b is pushed by the first cam surface 81b and the second cam surface 81c. The sheet S is carried by the aligning roller pair 54 of the supply mechanism 14 in proper timing so that the leading end S₁ is inserted to the grip pawl 71a in the open position.

FIG. 7 shows the state where the drum 12 is further rotated from the state of FIG. 6. The cam follower 71b of the leading end gripper 71 is already finished with climbing over the cam surfaces 81b and 81c of the leading end gripper pusher 81. Since the grip pawl 71a is closed by the elastic force of the spring 76, the leading end S₁ of the sheet S is nipped by the leading end gripper 71. The drum 12 rotates in the state where the leading end S₁ of the sheet S is thus nipped by the leading end gripper 71. Therefore, the sheet S becomes wound on the circumferential surface of the drum 12.

After that, as shown in FIG. 8, the leading end gripper cam 80 rotates to the retreat position again. When the leading end gripper cam 80 is at the retreat position, the cam surface 80a does not push the leading end gripper pusher 81. Therefore, the closed position of the leading end gripper 71 is maintained irrespective of the rotation position of the drum 12. Thus, the drum 12 can rotate while keeping the state where the leading end S₁ of the sheet S is nipped by the leading end gripper 71.

Next, the trailing end gripper 91 and the trailing end gripper driving mechanisms 92 and 92′ will be described with reference to FIG. 3 and FIG. 9 to FIG. 17. In the case of this embodiment, plural (for example, two) trailing end grippers 91 are arranged in the circumferential direction of the drum 12. Since the trailing end grippers 91 have the same configuration as each other, FIG. 3 and FIG. 9 to FIG. 17 show only one trailing end gripper 91.

The trailing end gripper 91 has a trailing end gripper body 95 extending in the direction of the axial line X1 of the drum 12, and gripper end parts 96 provided respectively at both ends of the trailing end gripper body 95. The trailing end gripper body 95 is opposite the circumferential surface of the drum 12. The pair of gripper end parts 96 can move in the rotating direction of the drum 12 along a pair of ring-shaped fixed guides 97. These fixed guides 97 are fixed to a fixed frame such as a frame of the casing 11, near both ends of the drum 12. Each gripper end part 96 is provided with a spring part 98 which elastically deforms by contacting the inner surface of the fixed guide 97. The spring part 98 energizes the trailing end gripper 91 toward the drum 12.

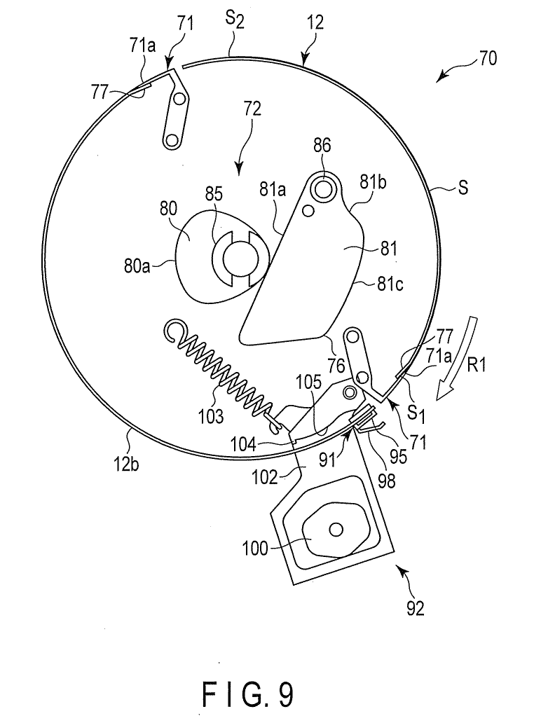

As shown in FIG. 3, the sheet carrying device 70 of this embodiment has the two types of trailing end gripper driving mechanism 92 and 92′. FIG. 9 to FIG. 17 shows the one trailing end gripper driving mechanism 92. The trailing end gripper driving mechanism 92 includes a trailing end gripper cam 100, a cam driving motor 101 (shown in FIG. 3), a trailing end gripper pusher 102, and a spring 103. The cam driving motor 101 rotates the trailing end gripper cam 100 by 90 degrees each. The trailing end gripper pusher 102 is reciprocated by the trailing end gripper cam 100. The spring 103 energizes the trailing end gripper pusher 102 toward the inside of the drum 12.

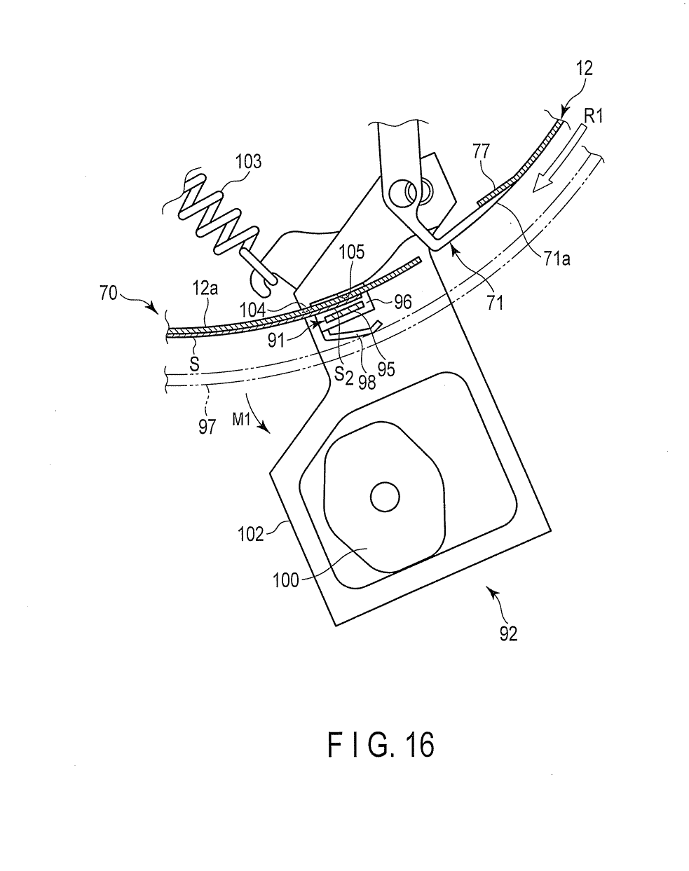

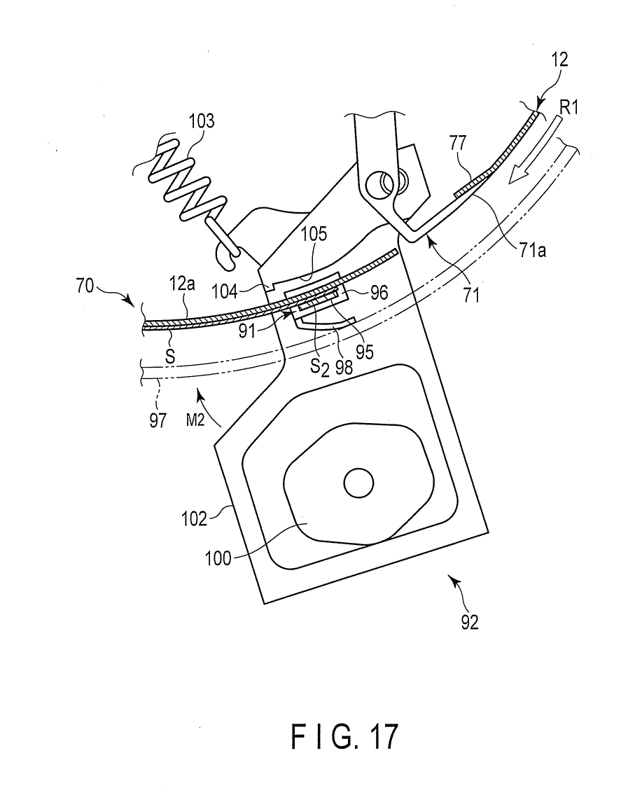

FIG. 16 and FIG. 17 show a part of the trailing end gripper 91 and the trailing end gripper driving mechanism 92, as enlarged. The trailing end gripper pusher 102 has a stopper 104 and a pushing surface 105. FIG. 16 shows the state where the trailing end gripper cam 100 is rotated to a first position. FIG. 17 shows the state where the trailing end gripper cam 100 is rotated to a second position.

As shown in FIG. 16, as the trailing end gripper cam 100 rotates to the first position, the trailing end gripper pusher 102 moves in the direction indicated by arrow M1 against the spring 103. Therefore, the stopper 104 protrudes to a position where the stopper 104 can engage with the gripper end part 96 of the trailing end gripper 91. Moreover, since the pushing surface 105 pushes the gripper end part 96, the trailing end gripper body 95 moves away from the drum 12. Therefore, the trailing end gripper 91 shifts to the state of being stopped relatively to the rotating drum 12, that is, shifts to a standby position (grip cancelation mode). Since the drum 12 continues rotating, the sheet S wound on the drum 12 passes through the inside of the trailing end gripper body 95, together with the leading end gripper 71.

As shown in FIG. 17, as the trailing end gripper cam 100 rotates to the second position, the trailing end gripper pusher 102 is moved by the spring 103 in the direction indicated by arrow M2. Therefore, the stopper 104 moves away from the trailing end gripper 91, and the pushing surface 105 no longer pushes the trailing end gripper 91. Thus, the trailing end gripper 91 is energized toward the drum 12 by the elastic force of the spring part 98. At this point, if the sheet S exists on the circumferential surface of the drum 12, a frictional force generated with the sheet S causes the trailing end gripper 91 to move in the rotating direction of the drum 12 together with the sheet S. That is, the trailing end gripper 91 switches to a grip position (grip mode). As the trailing end gripper 91 reaches the grip position, a trailing end S₂ of the sheet S is nipped between the drum 12 and the trailing end gripper 91. An inner surface (a surface facing the sheet S) of the trailing end gripper body 95 has an appropriate coefficient of friction so as to be able to frictionally engage with the sheet S.

Next, the operation of the trailing end gripper 91 will be described with reference to FIG. 9 to FIG. 17.

FIG. 9 shows the state immediately before the trailing end gripper driving mechanism 92 starts operating. By the elastic force of the spring 103, the stopper 104 of the trailing end gripper pusher 102 is at a position (retreat position) where the stopper 104 does not stop the trailing end gripper 91. The trailing end gripper 91 is energized in the direction of contacting the drum 12 as the spring part 98 elastically deforms. Therefore, the trailing end gripper 91 rotates together with the drum 12. At this point, the trailing end gripper 91 rotates together with the drum 12 at a position upstream from the leading end gripper 71 in relation to the rotating direction of the drum 12.

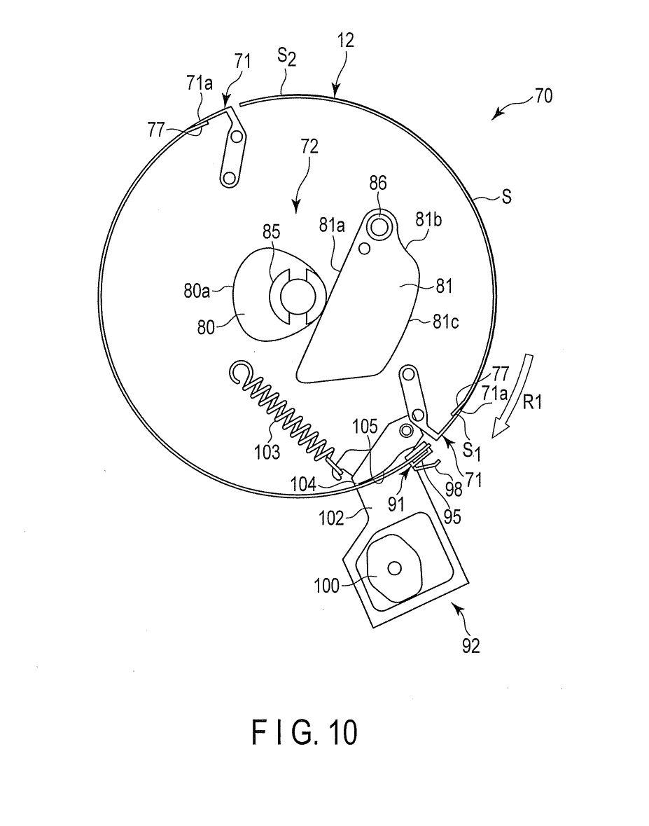

FIG. 10 shows the state immediately after FIG. 9, where the trailing end gripper cam 100 is rotated 90 degrees. The trailing end gripper pusher 102 is pushed by the trailing end gripper cam 100. Therefore, the trailing end gripper pusher 102 causes the stopper 104 to protrude toward the trailing end gripper 91. That is, the stopper 104 moves to a protruding position.

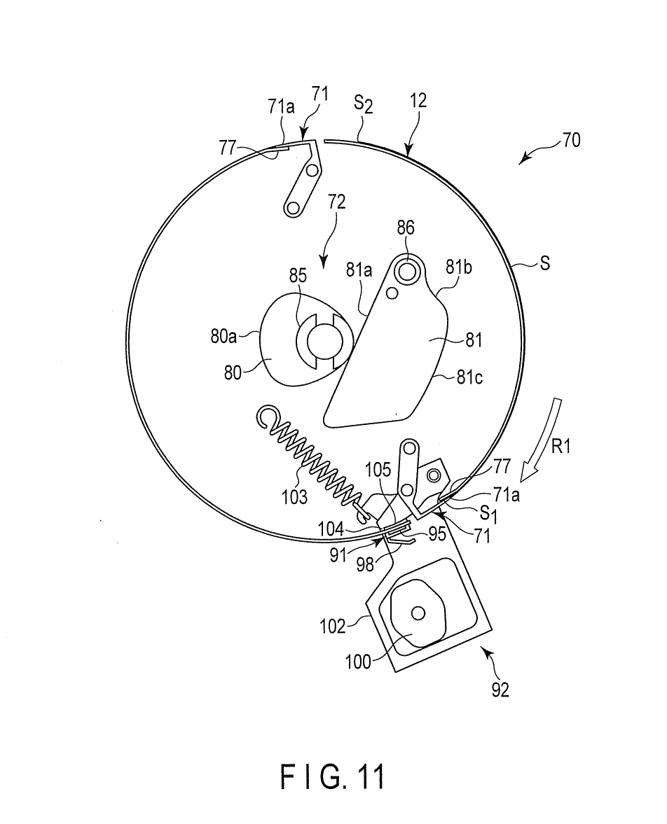

FIG. 11 shows the state where the drum 12 is further rotated from the state of FIG. 10. The trailing end gripper 91 runs onto the pushing surface 105 of the trailing end gripper pusher 102. Moreover, the trailing end gripper 91 is prevented from moving by the stopper 104. Therefore, the trailing end gripper 91 stops and switches to the standby position (grip cancelation mode). The drum 12 continues rotating.

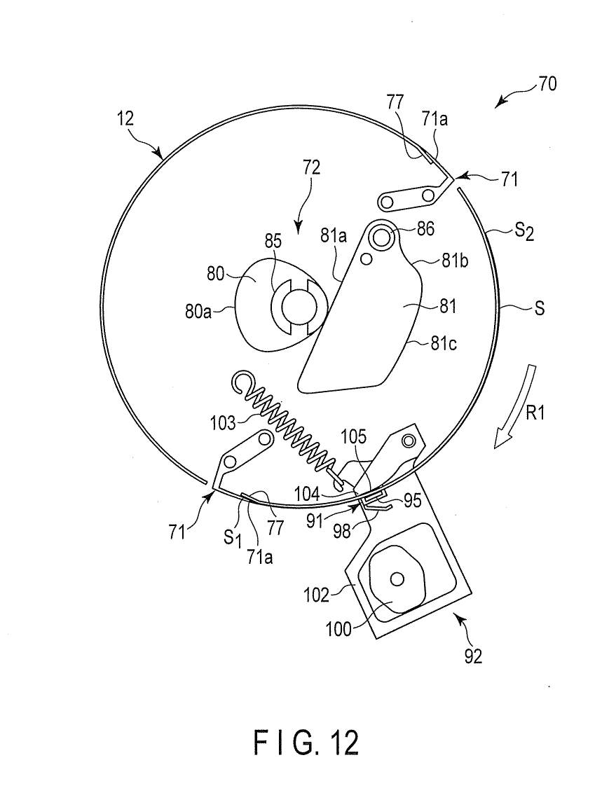

FIG. 12 shows the state where the drum 12 is further rotated from the state of FIG. 11. The trailing end gripper 91 remains stopped by the stopper 104. However, since the drum 12 continues rotating, the leading end gripper 71 and the sheet S follow the rotation of the drum 12 and pass through the inside of the trailing end gripper body 95.

On the circumferential surface of the drum 12, the sloped concave surface 77 is formed at the position where the grip pawl 71a is arranged. The leading end S₁ of the sheet S is slightly withdrawn in a state inclined inward of the drum 12, along the sloped concave surface 77. Therefore, when the leading end S₁ of the sheet S passes through the inside of the trailing end gripper body 95, the leading end S₁ of the sheet S can avoid being caught on the trailing end gripper body 95. Therefore, the leading end S₁ of the sheet S is smoothly inserted to the trailing end gripper 91 that is stopped in the standby position.

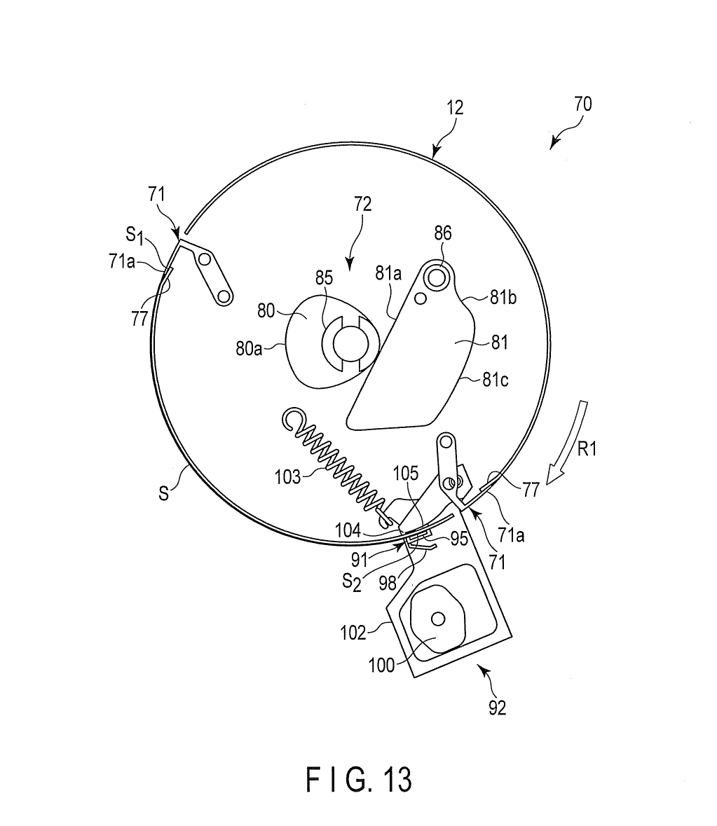

FIG. 13 and FIG. 16 show the state where the drum 12 is further rotated from the state of FIG. 12. Since the drum 12 rotates, the trailing end S₂ of the sheet S approaches the stopped trailing end gripper 91. This timing is immediately before the trailing end gripper cam 100 stars moving from the first position toward the second position.

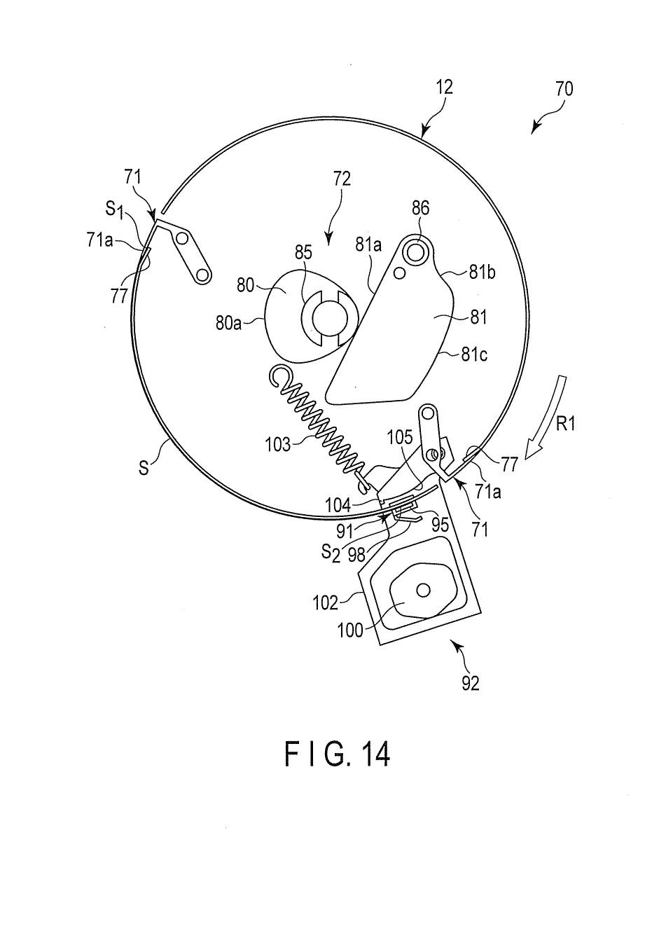

FIG. 14 and FIG. 17 show the state where the drum 12 is further rotated from the state of FIG. 13 and the trailing end gripper cam 100 is rotated 90 degrees (to the second position). As the trailing end gripper cam 100 rotates 90 degrees and reaches the second position, the stopper 104 of the trailing end gripper pusher 102 is moved away from the trailing end gripper 91 by the elastic force of the spring 103. Therefore, the restriction of the trailing end gripper 91 is canceled. That is, the trailing end gripper 91 is released. As the trailing end gripper 91 is released, the frictional force between the trailing end gripper body 95 and the sheet S causes the trailing end gripper 91 to move in the rotating direction of the drum 12 together with the trailing end S₂ of the sheet S. That is, the trailing end gripper 91 switches to the grip position (grip mode).

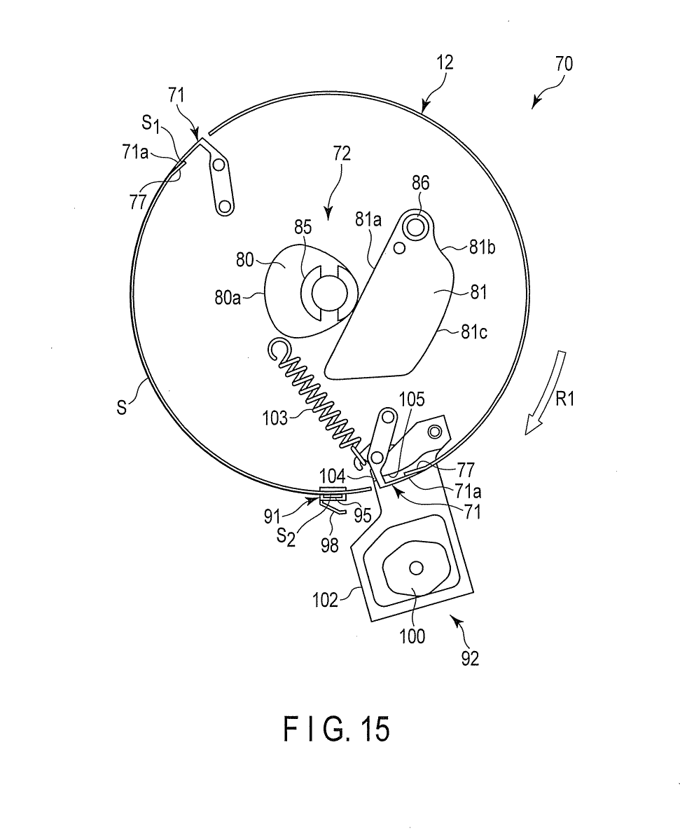

FIG. 15 shows the state where the drum 12 is further rotated from the state of FIG. 14. The trailing end gripper 91 rotates together with the drum 12 while preventing the trailing end S₂ of the sheet S from floating. In this manner, the trailing end gripper driving mechanism 92 of this embodiment is configured to cause the trailing end gripper 91 to frictionally engage with the sheet S in timing when the trailing end S₂ of the sheet S reaches the trailing end gripper 91. Therefore, the trailing end S₂ of the sheet S can be nipped irrespective of the length of the sheet S.

The second trailing end gripper driving mechanism 92′ shown in FIG. 3 is arranged upstream from the stripping mechanism (the neutralizing charger 18 and the stripping member 19 shown in FIG. 1) in relation to the rotating direction of the drum 12. The functions of the second trailing end gripper driving mechanism 92′ are substantially the same as the functions of the first trailing end gripper driving mechanism 92. That is, the second trailing end gripper driving mechanism 92′ includes a trailing end gripper cam 100′, a cam driving motor 101′, a lever-shaped trailing end gripper pusher 102′, a spring 103′, a stopper 104′ and the like.

When the stopper 104′ of the trailing end gripper pusher 102′ is at the retreat position, the trailing end gripper 91 can move in the rotating direction of the drum 12 while continuing nipping the trailing end S₂ of the sheet S. As the stopper 104′ of the trailing end gripper pusher 102′ is moved to the protruding position by the trailing end gripper cam 100′, the trailing end gripper 91 is stopped by the stopper 104′. Since the sheet S continues rotating together with the drum 12, the trailing end S₂ of the sheet S exits the trailing end gripper 91. The sheet S goes through the neutralizing charger 18 and the stripping member 19 and is carried to the discharge mechanism 21.

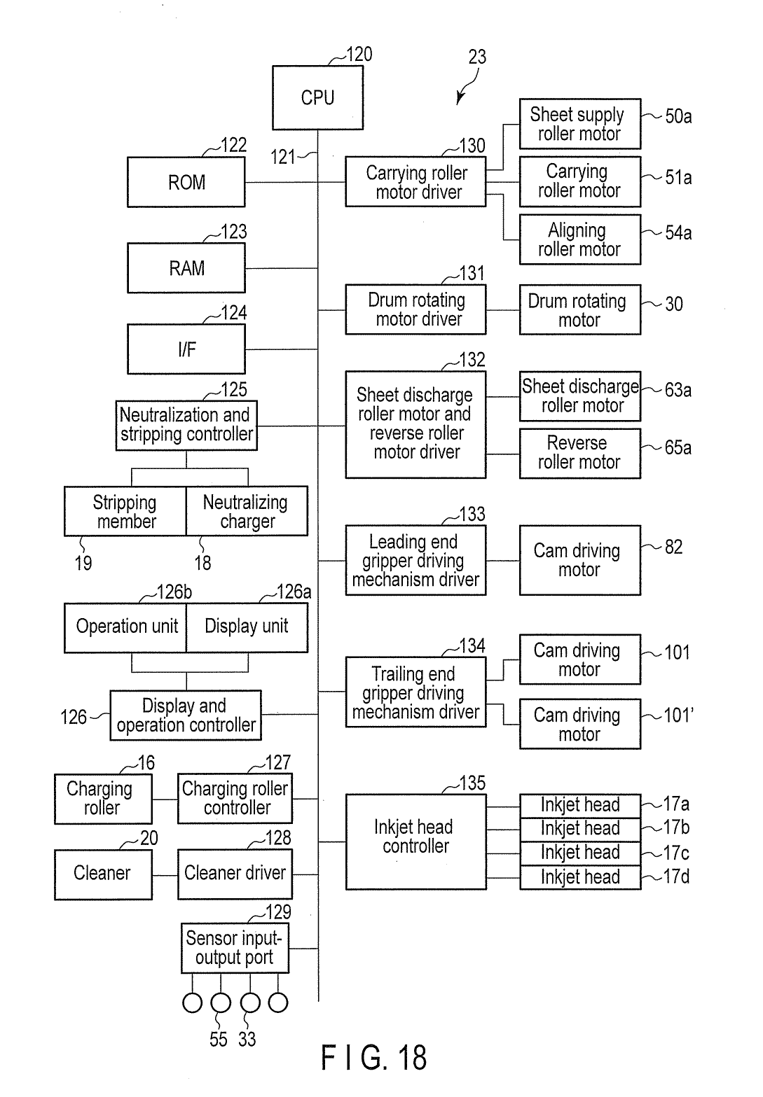

FIG. 18 is a block diagram showing the configuration of the controller 23 in the printer 10 of this embodiment. The controller 23 has a CPU (central processing unit) 120 functioning as a processor. A ROM (read only memory) 122, a RAM (random access memory) 123, a communication interface unit 124, a neutralization and stripping controller 125, a display and operation controller 126, a charging roller controller 127, a cleaner driver 128, a sensor input-output port 129, a carrying roller motor driver 130, a drum rotating motor driver 131, a sheet discharge roller motor and reverse roller motor driver 132, a leading end gripper driving mechanism driver 133, a trailing end gripper driving mechanism driver 134, an inkjet head controller 135 and the like are connected to the CPU 120 via a bus line 121.

In the ROM 122, a program for controlling the CPU 120 and various fixed data area stored. In the RAM 123, various memory areas for storing various data necessary for image formation are formed. The communication interface unit 124 controls data communication carried out with an external device via a communication channel. The neutralization and stripping controller 125 controls the neutralizing charger 18 and the stripping member 19. The display and operation controller 126 controls a display unit 126a having a touch panel, and an operation unit 126b. By operating the operation unit 126b, necessary information for image formation and information such as sheet size can be stored in the RAM 123. The charging roller controller 127 controls the DC voltage supplied to the charging roller 16. The cleaner driver 128 drives the cleaner 20. Various sensors (for example, the rotation angle sensor 33 and the sheet size sensor 55) are connected to the sensor input-output port 129.

The carrying roller motor driver 130 drives a motor 50a of the pickup roller 50, a motor 51a of the sheet supply roller 51, and a motor 54a of the aligning roller pair 54. The drum rotating motor driver 131 drives the motor 30 which rotates the drum 12. The sheet discharge roller motor and reverse roller motor driver 132 drives a motor 63a of the sheet discharge roller 63 and a motor 65a of the reverse roller 65.

The leading end gripper driving mechanism driver 133 drives the cam driving motor 82 of the leading end gripper driving mechanism 72. The trailing end gripper driving mechanism driver 134 drives the cam driving motors 101 and 101′ of the trailing end gripper driving mechanisms 92 and 92′. The inkjet head controller 135 controls ink ejection of the inkjet heads 17a, 17b, 17c and 17d.

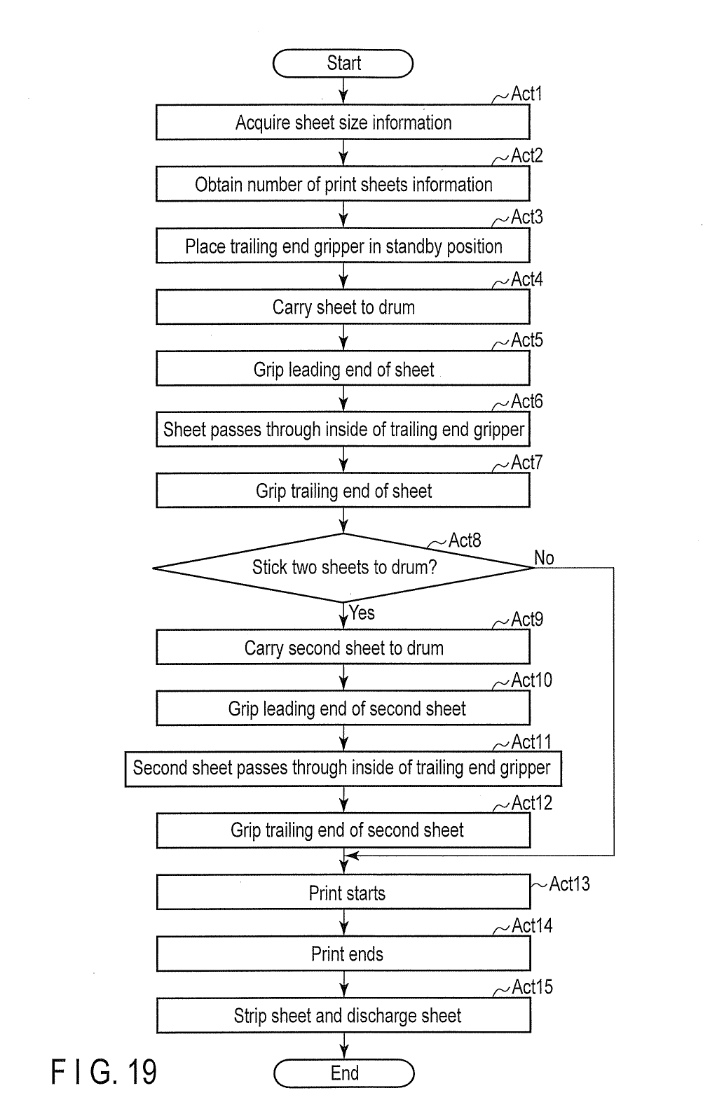

Hereinafter, an action of an image forming process by the printer 10 of this embodiment will be described with reference to the flowchart of FIG. 19.

In Act 1 of FIG. 19, sheet size information is acquired. To acquire the sheet size, the sheet size can be manually inputted by operating the operation unit 126b (shown in FIG. 18). The sheet size may be detected by the sheet size sensor 55 (shown in FIG. 3 and FIG. 18). In Act 2, number of print sheets information is acquired. The drum 12 rotates in the direction of arrow R1 shown in FIG. 1 to FIG. 17.

In Act 3, the trailing end gripper 91 is situated in the standby position (the grip cancelation mode in FIG. 16). That is, the trailing end gripper cam 100 is rotated to the first position by the trailing end gripper driving mechanism 92, thus moving the trailing end gripper pusher 102 in the direction indicated by arrow M1. The stopper 104 moves to the protruding position. Thus, the trailing end gripper 91 is prevented from moving by the stopper 104 and stops in the standby position.

In Act 4, the sheet S housed in the sheet housing unit 13 is carried between the drum 12 and the charging roller 16 by the supply mechanism 14. Meanwhile, a DC voltage is applied to the charging roller 16 by the power supply circuit 45.

In Act 5, the leading end gripper cam 80 rotates to the protruding position shown in FIG. 6, thus bringing the leading end gripper 71 into the open position. The controller 23 controls operation timing of the supply mechanism 14 so that the leading end S₁ of the sheet S carried by the supply mechanism 14 is inserted to the leading end gripper 71 in the open position. The sheet S supplied between the drum 12 and the charging roller 16 contacts the charging roller 16 and is thereby charged with an electric charge of a first polarity. The dielectric layer 42 (shown in FIG. 2) of the drum 12 is charged with an electric charge of a second polarity. This electrostatic force attracts the sheet S to the circumferential surface of the drum 12. As the leading end gripper 71 moves to the closed position, the leading end S₁ of the sheet S is nipped by the leading end gripper 71. The sheet S moves together with the drum 12 in the rotating direction R1 of the drum 12.

In Act 6, the leading end gripper 71 and the sheet S on the drum 12 follow the rotation of the drum 12 and pass through the inside of the trailing end gripper 91. At this point, the trailing end gripper 91 is in the standby position (the grip cancelation mode in FIG. 16). On the circumferential surface of the drum 12, the sloped concave surface 77 is formed in which the grip pawl 71a fits. The leading end S₁ of the sheet S is slightly bent inward of the drum 12 along the sloped concave surface 77. Therefore, when the leading end S₁ of the sheet S passes through the inside of the trailing end gripper body 95, the leading end S₁ of the sheet S can avoid being caught on the trailing end gripper body 95. Moreover, since the leading end S₁ of the sheet S is slightly bent inward along the sloped concave surface 77, the leading end S₁ of the sheet S can be smoothly inserted into the trailing end gripper body 95.

In Act 7, when the trailing end S₂ of the sheet S passing through the inside of the trailing end gripper 91 reaches the trailing end gripper 91, the trailing end gripper cam 100 rotates to the second position shown in FIG. 17. Then, the stopper 104 moves to the retreat position. Thus, since the stopper 104 moves away from the trailing end gripper 91, the restriction of the trailing end gripper 91 stopped in the standby position (FIG. 16) up to this point is canceled. That is, the trailing end gripper 91 is released.

The released trailing end gripper 91 is pressed toward the sheet S by the elastic force of the spring part 98. The frictional force generated with the sheet S causes the trailing end gripper 91 to move in the rotating direction of the drum 12 together with the trailing end S₂ of the sheet S. That is, as the trailing end gripper 91 switches to the grip position (grip mode), the trailing end S₂ of the sheet S is nipped between the circumferential surface of the drum 12 and the trailing end gripper 91.

In Act 8, whether there is a succeeding sheet or not is determined by a sensor which detects the presence or absence of a sheet or on the basis of the number of print sheets information inputted to the controller 23 in advance. If there is a succeeding sheet, the processing shifts to Act 9. If there is no succeeding sheet, the processing shifts to Act 13.

In Act 9, the second sheet S is carried to the drum 12 by the supply mechanism 14 as in the case of the first sheet S. In Act 10, the leading end gripper 71 shifts to the open position as shown in FIG. 6. After the leading end S₁ of the second sheet S is inserted to a second leading end gripper 71, the leading end gripper 71 closes. Then, in Act 11, the second sheet S passes through the inside of a second trailing end gripper 91. At this point, the second trailing end gripper 91 is stopped in the standby position (FIG. 16) by the stopper 104.

In Act 12, when the trailing end S₂ of the second sheet S reaches the second trailing end gripper 91, the trailing end gripper cam 100 moves to the second position (FIG. 17). Thus, since the stopper 104 moves to the retreat position, the second trailing end gripper 91 is released and switched to the grip mode. Thus, the trailing end S₂ of the second sheet S is nipped by the second trailing end gripper 91. In this manner, the second sheet S, too, moves in the rotating direction R1 of the drum 12.

In Act 13, print is started. In the case of color print, as the sheet S reaches the first inkjet head 17a, a first color ink is ejected to the sheet S from the first inkjet head 17a. The sheet S rotates while remaining attracted to the drum 12, and the sheet S reaches the second inkjet head 17b. Then, a second color ink is ejected to the sheet S from the second inkjet head 17b. As the drum 12 rotates further, a third color ink is ejected to the sheet S from the third inkjet head 17c. As the drum 12 rotates further, a fourth color ink is ejected to the sheet S from the fourth inkjet head 17d. Thus, an image is formed on the sheet S while the drum 12 rotates. That is, the printer 10 performs color print based on a line head-type multipath system.

As print is finished in Act 14, an AC voltage is applied by the neutralizing charger 18 to the sheet S with the image formed thereon. Thus, the attraction force of the sheet S to the drum 12 is reduced. Moreover, the leading end gripper 71 is opened by the leading end gripper driving mechanism 72, thus releasing the leading end S₁ of the sheet S. The second trailing end gripper driving mechanism 92′ shown in FIG. 3 moves the stopper 104′ of the trailing end gripper pusher 102′ to the protruding position, thus causing the trailing end gripper 91 to stop. Since the sheet S keeps moving together with the drum 12, the trailing end S₂ of the sheet S exits the trailing end gripper 91. The sheet S is stripped off the drum 12 by the stripping member 19, goes through the carrying guide 61 and the sheet discharge roller 63 and is discharged onto the sheet discharge table 64.

In the case of double-side print, after an image is formed by the recording head unit 17 on a first side of the sheet S which is carried with the first side being the face side, the sides of the sheet S are reversed by the reverse mechanism 22. The sheet S is carried again to the drum 12 with a second side of the sheet S being the face side. An image is formed on the second side by the recording head unit 17.

According to the sheet carrying device 70 of this embodiment, in addition to the attraction of the sheet S to the circumferential surface of the drum 12 by an electrostatic attraction force, the leading end S₁ and the trailing end S₂ of the sheet S which tend to be stripped off the drum 12 are held by the leading end gripper 71 and the trailing end gripper 91. Therefore, the sheet S can be securely held on the circumferential surface of the drum 12 even when the drum 12 rotates at a high speed. Moreover, when the sheet S absorbs moisture from the ink ejected at the time of image formation, a bending stress is generated in the sheet S. Even such a sheet S can be firmly held on the circumferential surface of the drum 12. Since the drum 12 rotates with the sheet S thus securely sticking to the drum 12, high-speed high-quality image formation can be performed and occurrence of sheet jam can be avoided.

According to the sheet carrying device 70 of this embodiment, the leading end gripper 71 and the sheet S pass through the inside of the trailing end gripper 91 stopped in the standby position by the stopper 104. Then, as the trailing end S₂ of the sheet S reaches the trailing end gripper 91, the stopper 104 moves to the retreat position and the trailing end gripper 91 is released. Therefore, the trailing end gripper 91 frictionally engages with the sheet S. Thus, the trailing end S₂ of the sheet S can be held by the trailing end gripper 91, irrespective of the size of the sheet. The size of the sheet is not limited to standard sizes such as A4, A5 and A3.

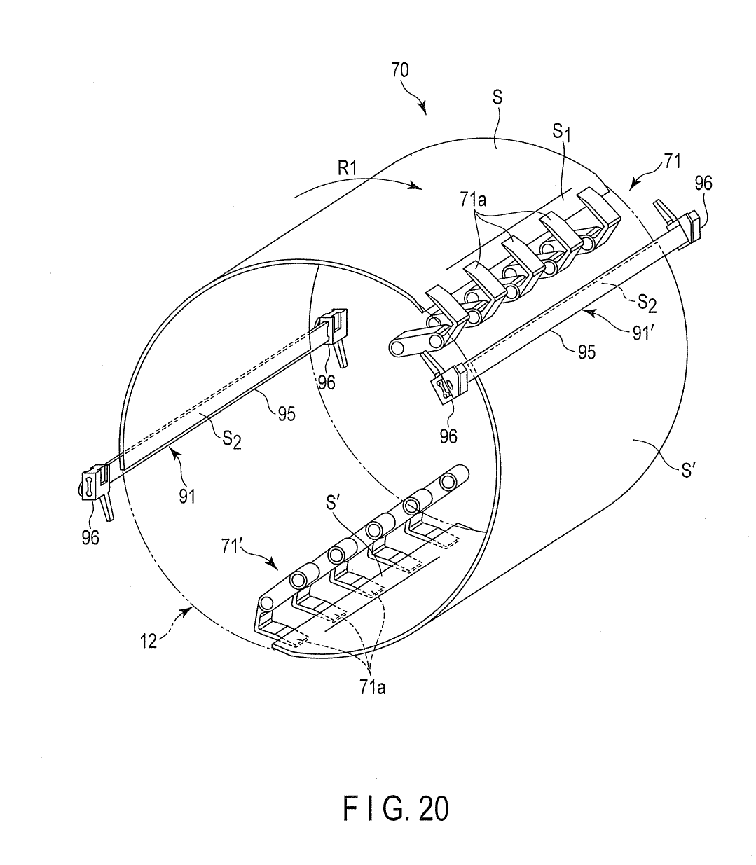

FIG. 20 shows the state where two A4-size sheets S and S′ are held on the drum 12. The leading end S₁ and the trailing end S₂ of the one sheet S are held by the one leading end gripper 71 and the one trailing end gripper 91, respectively. The leading end S₁ and the trailing end S₂ of the other sheet S′ are held by the other leading end gripper 71′ and the other trailing end gripper 91′, respectively.

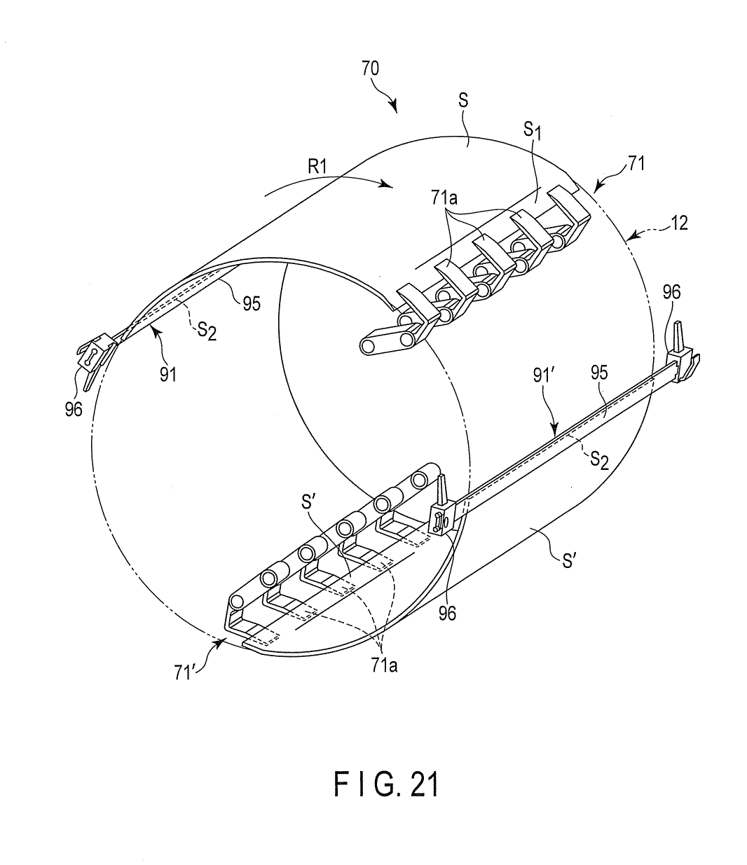

FIG. 21 shows the state where two A5-size sheets S and S′ are held on the drum 12. The leading end S₁ and the trailing end S₂ of the one sheet S are held by the one leading end gripper 71 and the one trailing end gripper 91, respectively. The leading end S₁ and the trailing end S₂ of the other sheet S′ are held by the other leading end gripper 71′ and the other trailing end gripper 91′, respectively.

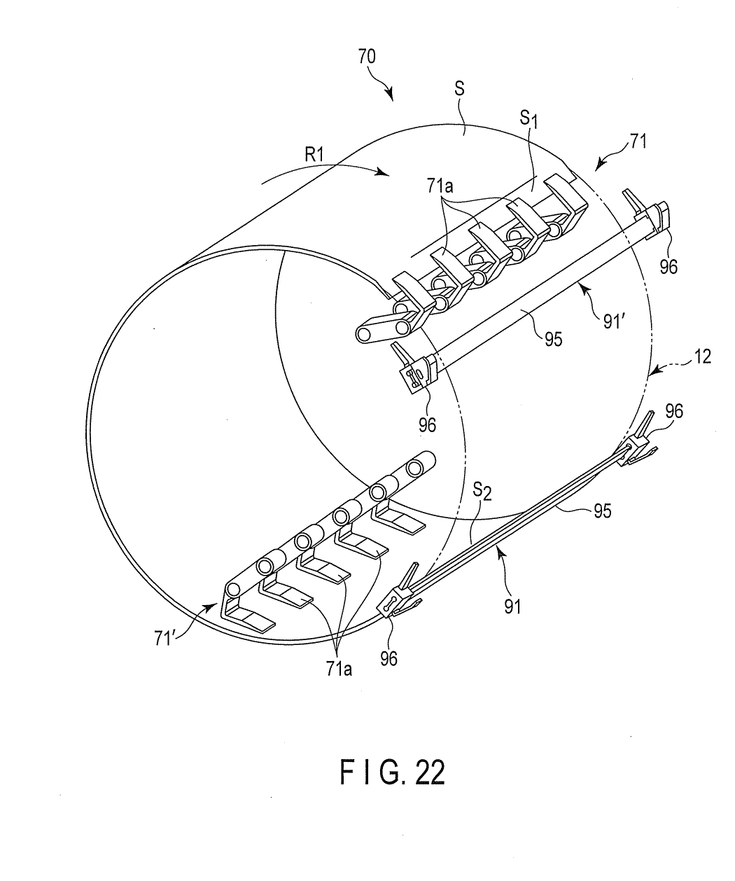

FIG. 22 shows the state where one A3-size sheet S is held on the drum 12. The leading end S₁ and the trailing end S₂ of the A3-size sheet S are held by the one leading end gripper 71 and the one trailing end gripper 91, respectively. The other leading end gripper 71′ and the other trailing end gripper 91′ are not used. In this manner, in the sheet carrying device 70 of this embodiment, the leading end and the trailing end of sheets of various sizes including non-standard sizes can be held on the drum 12 by the leading end gripper 71 and the trailing end gripper 91.

In the embodiment, the spring part 98 is made to contact the inner surface of the ring-shaped fixed guide 97, thus energizing the trailing end gripper 91 toward the drum 12. However, as an alternative embodiment, a spring provided on the trailing end gripper may be made to contact the inner surface of a flange 12c of the drum 12 and elastically deformed, thus energizing the trailing end gripper toward the drum. Moreover, the trailing end gripper pusher need not have the pushing surface 105 and may simply have the stopper. The stopper moves to the protruding position where the stopper prevents the trailing end gripper from moving in relation to the rotating drum and to the retreat position where the stopper allows the trailing end gripper to move. Each embodiment may also apply to a thermal printer or a wire dot printer as well as the inkjet printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording medium carrying device comprising:
a drum including a circumferential surface to hold a recording medium;
a rotation mechanism which rotates the drum in a circumferential direction;
a leading end gripper which is arranged on the drum and moves to an open position where a leading end of the recording medium is inserted in the leading end gripper and a closed position where the leading end gripper nips the leading end of the recording medium;
a leading end gripper driving mechanism which opens and closes the leading end gripper, and which moves the leading end gripper to the open position before the leading end of the recording medium reaches the leading end gripper, and moves the leading end gripper to the closed position in a state where the leading end of the recording medium is inserted in the leading end gripper;
a trailing end gripper which is arranged on the drum and switches between a standby position where the trailing end gripper stops relatively to the rotating drum and a grip position where the trailing end gripper moves together with the drum in a rotating direction of the drum; and
a trailing end gripper driving mechanism which switches the trailing end gripper between the standby position and the grip position, and which stops the trailing end gripper in the standby position, thereby causing the leading end gripper and the recording medium to pass through an inside of the trailing end gripper, and releases the trailing end gripper as a trailing end of the recording medium reaches the trailing end gripper, thus causing the trailing end gripper and the recording medium to move together with the drum in the rotating direction of the drum.

2. The device according to claim 1, wherein the leading end gripper comprises a grip pawl which opens toward a rear side in the rotating direction of the drum, at the open position.

3. The device according to claim 2, wherein a sloped concave surface for accepting the grip pawl that is moved to the closed position is provided at a position where the grip pawl is arranged on the circumferential surface of the drum.

4. The device according to claim 3, wherein the sloped concave surface continues in an axial direction of the drum.

5. The device according to claim 4, wherein the grip pawl comprises an outer surface continuing with a substantially flush surface to the circumferential surface of the drum, in the state where the grip pawl is moved to the closed position.

6. The device according to claim 1, wherein the leading end gripper driving mechanism comprises a leading end gripper cam which is rotated by a cam driving motor, a leading end gripper pusher which is pushed as the leading end gripper cam rotates in a protruding direction, and a cam follower, which contacts the leading end gripper pusher and thereby moves the leading end gripper to the open position.

7. The device according to claim 1, wherein in addition to the leading end gripper, another leading end gripper is further arranged in the circumferential direction of the drum.

8. The device according to claim 1, wherein in addition to the trailing end gripper, another trailing end gripper is further arranged in the circumferential direction of the drum.

9. The device according to claim 1, wherein the trailing end gripper comprises a trailing end gripper body which extends in an axial direction of the drum, opposite the circumferential surface of the drum, and a gripper end part situated at both ends of the trailing end gripper body, and the trailing end gripper body comprises an inner surface which generates a frictional force with the recording medium.

10. The device according to claim 9, wherein the trailing end gripper comprises a spring part which energizes the trailing end gripper body toward the circumferential surface of the drum.

11. The device according to claim 9, wherein the trailing end gripper driving mechanism comprises a stopper which moves a protruding position where the stopper engages with the trailing end gripper and a retreat position where the stopper is away from the trailing end gripper.

12. The device according to claim 11, wherein the trailing end gripper driving mechanism comprises a trailing end gripper pusher which moves the stopper to the retreat position.

13. The device according to claim 9, wherein the trailing end gripper driving mechanism comprises a pushing surface which moves the trailing end gripper body in a direction away from the circumferential surface of the drum.

14. The device according to claim 9, wherein the trailing end gripper comprises a spring part which contacts an inner surface of a ring-shaped fixed guide arranged near both ends of the drum and thus elastically deforms, thereby energizing the trailing end gripper body toward the circumferential surface of the drum.

15. The device according to claim 9, wherein the trailing end gripper comprises a spring part which contacts an inner surface of a flange of the drum and thus elastically deforms, thereby energizing the trailing end gripper body toward the circumferential surface of the drum.

16. An image forming apparatus comprising:
a drum including a circumferential surface to hold a recording medium;
a rotation mechanism which rotates the drum in a circumferential direction;
at least one leading end gripper which is arranged on the drum and moves to an open position where a leading end of the recording medium is inserted in the leading end gripper and a closed position where the leading end gripper nips the leading end of the recording medium;
a leading end gripper driving mechanism which opens and closes the leading end gripper, and which moves the leading end gripper to the open position before the leading end of the recording medium reaches the leading end gripper, and moves the leading end gripper to the closed position in a state where the leading end of the recording medium is inserted in the leading end gripper;
at least one trailing end gripper which is arranged on the drum and switches between a standby position where the trailing end gripper stops relatively to the rotating drum and a grip position where the trailing end gripper moves together with the drum in a rotating direction of the drum;
a trailing end gripper driving mechanism which switches the trailing end gripper between the standby position and the grip position, and which stops the trailing end gripper in the standby position, thereby causing the leading end gripper and the recording medium to pass through an inside of the trailing end gripper, and releases the trailing end gripper as a trailing end of the recording medium reaches the trailing end gripper, thus causing the trailing end gripper and the recording medium to move together with the drum in the rotating direction of the drum;
a supply mechanism which supplies the recording medium toward the circumferential surface of the drum;
a recording head unit which is arranged opposite the circumferential surface of the drum and forms an image on the recording medium;
a stripping mechanism which strips the recording medium with the image formed thereon from the drum; and
a controller which drives the trailing end gripper driving mechanism according to a size of the recording medium.

17. The apparatus according to claim 16, comprising:
a dielectric layer which is provided on the circumferential surface of the drum and is provided with an electric charge for electrostatically attracting the recording medium; and
a charging roller which provides the dielectric layer with the electric charge.

18. The apparatus according to claim 16, wherein the leading end gripper comprises a grip pawl which opens toward a rear side in the rotating direction of the drum, at the open position, and
comprises a sloped concave surface for accepting the grip pawl that is moved to the closed position, at a position where the grip pawl is arranged on the circumferential surface of the drum.

19. The apparatus according to claim 16, wherein the controller controls the supply mechanism so that the leading end of the recording medium is inserted into the leading end gripper that is moved to the open position.

20. The apparatus according to claim 16, comprising:
a first trailing end gripper driving mechanism which is arranged downstream from the supply mechanism in relation to the rotating direction of the drum, and if the trailing end of the recording medium reaches one trailing end gripper, switches the trailing end gripper from the standby position to the grip position; and
a second trailing end gripper driving mechanism which is arranged upstream from the stripping mechanism in relation to the rotating direction of the drum and switches the trailing end gripper from the grip position to the standby position.

21. A recording medium carrying method comprising:
rotating a drum comprising a leading end gripper and a trailing end gripper;
moving the leading end gripper to an open position;
inserting a leading end of a recording medium into the leading end gripper that is moved to the open position;
moving the leading end gripper to a closed position and thereby nipping the leading end of the recording medium by the leading end gripper;
stopping the trailing end gripper in a standby position in relation to the drum that is rotating;
the leading end gripper and the recording medium passing through an inside of the trailing end gripper that is stopped;
releasing the trailing end gripper and nipping the trailing end of the recording medium between the drum and the trailing end gripper, if a trailing end of the recording medium reaches the trailing end gripper,; and
moving the recording medium nipped by the leading end gripper and the trailing end gripper, together with the drum in a rotating direction of the drum.

22. The method according to claim 21, wherein the recording medium is supplied toward the leading end gripper so that the leading end of the recording medium is inserted into the leading end gripper that is moved to the open position.

23. The method according to claim 21, comprising:
providing a circumferential surface of the drum with an electric charge for electrostatic attraction;
electrostatically attracting the recording medium to the circumferential surface of the drum by the electric charge;
nipping the leading end of the recording medium by the leading end gripper; and
nipping the trailing end of the recording medium by the trailing end gripper.

24. The method according to claim 21, wherein the leading end of the recording medium nipped by the leading end gripper is bent inward of the drum by the leading end gripper, and the leading end gripper and the recording medium pass through the inside of the trailing end gripper.

25. The method according to claim 21, wherein before the recording medium nipped by the leading end gripper and the trailing end gripper reaches a stripping mechanism, the trailing end gripper is stopped, thus causing the trailing end of the recording medium to exit the trailing end gripper.
